(19) United States
(12) Patent Application Publication
(10) Pub. No.: US 2015/0258703 A1
(43) Pub. Date: Sep. 17, 2015

(54) Hand-Held Tool Apparatus with a Braking Device for Braking of a Machining Tool

(71) Applicant: HILTI AKTIENGESELLSCHAFT, Schaan (LI)

(72) Inventors: Adrian Steingruber, Schwabmuenchen (DE); Florian Leistner, Neustadt (DE)

(73) Assignee: Hilti Aktiengesellschaft, Schaan (LI)

(21) Appl. No.: 14/433,312

(22) PCT Filed: Oct. 2, 2013
(86) PCT No.: PCT/EP2013/070498

§ 371 Date: Apr. 2, 2015

(30) Foreign Application Priority Data
Oct. 3, 2012 (DE) 10 2012 218 073.7

(51) Int. Cl. B27B 17/08; B27B 5/38; B24B 47/26; F16D 49/10

(52) U.S. Cl. CPC B27B 17/083; F16D 49/10; B27B 5/38; B24B 47/26

(57) ABSTRACT

A hand-held tool apparatus with a braking device for braking a machining tool is disclosed. The tool has a rear handle for operation of the tool apparatus, a drive device for driving of the machining tool around an axis of rotation, a band brake with a brake drum and a brake band that wraps around the brake drum, and an operating device with a brake switch for the actuation of the band brake. The brake switch is connected by a transmission device with a first end of the brake band. A rotationally mounted compensator device includes a rotationally mounted lever connected with the transmission device and a spring element, where the compensator device is interposed between the transmission device and the brake switch. The spring element is connected on a first end with the brake switch and is in contact on a second end under bias with the lever.

This application claims the priority of International Application No. PCT/EP2013/070498, filed Oct. 2, 2013, and German Patent Document No. 10 2012 218 073.7, filed Oct. 3, 2012, the disclosures of which are expressly incorporated by reference herein.

### BACKGROUND AND SUMMARY OF THE INVENTION

This invention relates to a hand-held tool apparatus with a braking device for braking a machining tool.

In the context of this invention, the term “tool apparatus” includes all tool units that drive a machining tool around an axis of revolution during the machining of the workpiece. Typical examples of such a tool apparatus are a diamond cutter, an angle grinder, a circular saw, a chainsaw and a core drill. “Hand-held” describes tools that are guided at least partly by hand during the processing of a workpiece. In addition to tools that are guided by the operator directly above the tool, hand-held tools also include tools that are installed on a guide carriage. In those cases, the tool apparatus is operated by means of a mechanical or electrical remote control device and the guide carriage with the tool apparatus is manually guided by the operator over the workpiece.

DE 36 39 650 A1 describes motorized chainsaws with a safety brake and a rundown brake. Both brakes actuate a common mechanical band brake with a brake drum and a brake band that wraps around the brake drum. The safety brake is a required safety device for motorized chainsaws that brings the saw chain to a stop within 150 milliseconds in the event of a strong return kick of the motorized chainsaw without any intervention on the part of the operator. In addition, the safety brake can be manually tripped by the operator by means of a hand guard. The hand guard is located between a front handle and the saw chain, and is actuated by a pivoting motion toward the saw chain. The front handle is located between the saw chain and a motor housing. In addition to the front handle, motorized chainsaws have a rear handle that is located on the side of the front handle facing away from the saw chain. The purpose of the rundown brake is to reduce by several seconds the time it takes the saw chain to come to a stop. The rundown brake consists of a brake switch and a transmission device (e.g. a Bowden cable), that is connected with the brake switch and the brake band of the band brake. The brake band is connected on a first end in a non-detachable manner with a housing part of the tool appliance, and on a second end is hooked to a rotationally mounted brake lever; the brake lever is biased by means of a brake spring and connected with the transmission device. The brake switch for the rundown brake on motorized chainsaws of the prior art is integrated into the gas switch for the actuation of the drive device for the saw chain or into the safety switch for the unlocking of the gas switch, whereby both switches are located on the rear handle. The gas switch is located on the inner side and the safety switch on the outer side of the rear handle.

The braking action of the band brake is determined primarily by the brake band, the brake drum and the brake spring. As the band brake is used, the dimensions of the brake band and of the brake drum change as result of wear, the length of the brake band increases and the diameter of the brake drum decreases. As a result of the wear of the brake band, the safety switch moves farther upward out of the rear handle. DE 36 39 650 A1 teaches that wear phenomena can be made visible by colored markings or other markings on the safety switch. If the brake band is broken or the change in the length of the brake band increases further, the safety switch moves out of the rear handle until it encounters a stop. A color marking, e.g. in the form of a red stripe, signals to the operator that the band brake is defective and the machine tool can no longer be braked. One disadvantage of this arrangement is that changes in the length of the band brake caused by wear can only be made visible, and there is no provision for compensation of the changes in length.

From DE 10 2007 024 170 A1 it is known that on hand-held tools, the brake band and/or the brake drum can be provided with a coating that contains diamond particles. The coating is designed to guarantee a uniform braking action and reduce wear of the band brake. The concentration of the diamond particles is between 30% and 50% and the diamond particles are embedded in a matrix that contains nickel. The coating of the brake band and/or of the brake drum with a coating that contains diamond particles is complicated to manufacture on the one hand and expensive on the other. In addition, no provision is made for changes in length in the band brake caused by wear.

The object of this invention consists in the development of a braking device for the braking of a machining tool that provides compensation for wear in the band brake using simple means, and that increases the useful life of the band brake.

The invention teaches that a rotationally mounted compensator device is interposed between the transmission device and the brake switch. The rotationally mounted compensation device between the transmission device and the brake switch on the one hand transmits the motion of the brake switch to the band brake, and on the other hand compensates for changes in the length of the band brake. The braking travel of the brake switch is increased by the compensator device. The compensator device increases the useful life of the band brake by the additional brake travel. Only when the changes in the length of the band brake have also compensated for the additional travel of the compensator device is a braking of the machine tool no longer possible and the band brake must be replaced.

The compensator device particularly preferably comprises a rotationally mounted lever that is connected with the transmission device and a spring element, whereby the spring element is connected on a first end with the brake switch in a non-detachable manner, and on a second end is in contact with a bias against the lever. The construction of the compensation device consisting of the lever and spring element is economical and easy to manufacture.

The spring element is particularly preferably in the form of a leaf spring and a driver for the leaf spring is provided on the brake switch. The second end of the leaf spring that is in contact with the lever particularly preferably has a shape that is complementary to that of the driver of the brake switch. As a result of the complementary shape of the driver on the brake switch and the second end of the leaf spring, the transmission of torque from the brake switch to the compensator device is improved. The torque transmission is defined by the surface areas of the driver and the leaf spring.

In one preferred embodiment of the invention, a rotationally mounted brake lever is interposed between the brake band and the transmission device, wherein the brake lever is biased by means of a brake spring. By means of the brake spring, a bias is exerted on the brake lever, which causes a permanent tension to be exerted on the brake band. The restoring force of the brake spring causes the brake lever to be rotated back into its base position if no external force is exerted on it.

It is particularly preferable if the stiffness of the spring of the spring element is significantly less than the spring stiffness of the brake spring. The spring stiffness of the spring element must overcome the friction forces in the transmission device. Because the spring element of the brake spring acts in the opposite direction, the spring stiffness of the spring element must be as low as possible in comparison to the brake spring. A high spring stiffness of the spring element would have to be compensated by the brake spring and the brake spring would have to be designed to be correspondingly stiffer.

In one preferred embodiment, the operating device has a gas switch for the actuation of the drive device and a safety switch for the unlocking of the gas switch, wherein the brake switch is separate from the gas switch and from the safety switch. The separate brake switch has the advantage that each switch can be actuated separately by the operator and it is not necessary to let go of the handle to actuate the band brake by letting go of the safety switch. The separate design of the switches guarantees that the operator grasps the handle during braking of the tool appliance and the risk of pitching movements during braking is reduced.

The gas switch and the brake switch are particularly preferably located respectively on an inner side of the rear handle and the safety switch on an outer side of the rear handle. The location of the gas and brake switches on the inner side of the rear handle has the advantage that the operator does not have to let go of the rear handle to release the switch and the risk of pitching movements is reduced. The safety switch that unlocks the gas switch can be located without any problem on the outer side of the rear handle because no function is carried out when the operator lets go of the safety switch. Therefore it is not necessary to let go of the rear handle during the operation of the tool appliance.

In one preferred embodiment of the invention, a tension spring is interposed between a second end of the brake band and a housing part of the tool appliance. The tension spring between the brake band and the housing part prevents a blocking of the brake band on the brake drum or quickly eliminates any blockage of the brake band. A tensile force is exerted on the brake band by means of the brake switch and the transmission device. As a result of the increasing friction between the curved surfaces of the brake band and the brake drum, the tensile force on the second end of the brake band increases and the kinetic friction of the brake band on the brake drum transitions into adherence. As a result of the increase of the tensile force on the brake band, a point is reached at which the tensile force on the second end of the brake band exceeds the force of the tension spring and the tension spring is stretched. As a result of the extension of the tension spring, the tensile force on the second end of the brake band is reduced and the adherence of the brake band on the brake drum transitions into kinetic friction; the blockage of the brake drum is eliminated. As soon as the tensile force on the second end of the brake band decreases to less than the force of the tension spring, the tension spring contracts and the brake band slides over the brake drum.

Particularly preferably the maximum expansion of the tension spring is limited by a first stop. As a result of the limitation of the maximum extension of the tension spring, an over-extension of the tension spring is securely prevented so that the tension spring has no wear or only slight wear and can return to its base position.

Particularly preferably the minimum extension of the tension spring is limited by a second stop. The tension spring is therefore biased even at the minimum extension. The limitation of the minimum expansion of the tension spring guarantees the return of the tension spring into its base position.

The brake band particularly preferably has a stop element that can be displaced between the first stop and the second stop. The stop element is located on the second end of the brake band closer to the tension spring. As a result of the mobility of the stop element between the stops, the extension of the tensile spring is limited. An over-extension of the tension spring is securely prevented, so that the tension spring has no wear or only slight wear, and can return to its base position.

The spring stiffness of the tension spring is particularly preferably significantly greater than the spring stiffness of the brake spring. The tension spring is designed to be significantly stiffer than the brake spring to ensure that the tension spring is extended only after the brake band adheres to and is blocked on the brake drum. As long as the brake band slides over the brake drum, the tension spring is in its base position and has no influence on the band brake. The spring stiffness of the tension spring is designed so that the tensile force on the second end of the brake band, when the brake band is blocked, exceeds the spring stiffness of the tension spring and the spring stiffness of the tension spring exceeds all other forces that occur in normal brake operation.

Exemplary embodiments of the invention are explained in greater detail below with reference to the accompanying drawing. The purpose of this drawing is not necessarily to illustrate the exemplary embodiments to scale. Instead, where useful to explain the invention, the drawing has been done in a schematic and/or slightly distorted form. With regard to additions to the teaching that is directly perceivable from the drawing, reference is made to the relevant prior art. It should thereby be taken into consideration that a wide range of modifications and changes regarding the form and details of an embodiment can be made without going beyond the general idea of the invention. The features of the invention disclosed in the description, the drawing and the claims can be essential for the development of the invention both individually in themselves as well as in any arbitrary combination. In addition, the scope of the invention includes all combinations of at least two of the features disclosed in the description, the drawing and/or the claims. The general idea of the invention is not limited to the exact form of details of the preferred embodiment illustrated and described below, or limited to an object that would be limited in comparison to the subject matter claimed in the claims. When ranges of dimensions are indicated, values that lie within the indicated limits are also disclosed as limit values and can be used and claimed arbitrarily. For the sake of simplicity, the same reference numbers are used below for identical or similar parts or parts with an identical or similar function.

### BRIEF DESCRIPTION OF THE DRAWINGS

FIG. 1 shows a hand-held tool apparatus claimed by the invention in the form of a diamond cutter with a braking device for braking a cutting disc and an operating device for the diamond cutter;

FIG. 2A, B shows the braking device of the diamond cutter illustrated in FIG. 1 consisting of a mechanical band brake with an anti-blocking device (FIG. 2A) and the anti-blocking device in detail (FIG. 2B);

FIG. 3A, B shows the control device for the diamond cutter illustrated in FIG. 1 with a gas switch, a safety switch and a brake switch in a basic position with the band brake actuated (FIG. 3A) and in a terminal position of the brake switch with the band brake open and the gas and safety switches actuated (FIG. 3B); and

FIG. 4 shows the braking device of the diamond cutter illustrated in FIG. 1 in the base position of the brake switch with a band brake altered by wear.

### DETAILED DESCRIPTION OF THE DRAWINGS

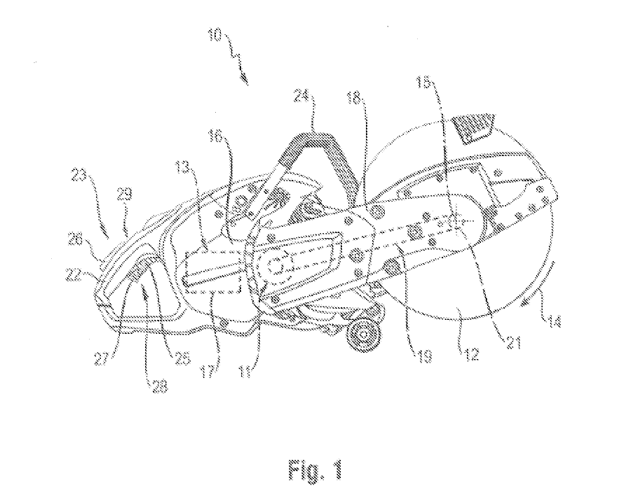

FIG. 1 is a three-dimensional representation of a hand-held tool apparatus 10 claimed by the invention that is in the form of a diamond cutter, with a braking device 11 to brake a drive device.

The diamond cutter 10 has a machining tool in the form of a cutting disc 12 that is driven by a drive device 13 in one direction of rotation 14 around an axis of rotation 15. The term “drive device” is used in this application to include all drive components for the cutting disc 12. The drive device 13 of the diamond cutter 10 illustrated in FIG. 1 comprises a drive motor 17 located in a motor housing 16, a belt drive 19 located in a bracket 18 and a driveshaft 21 on which the cutting disc 12 is mounted. If necessary, additional transmission components can be interposed between the drive motor 17 and the belt drive 19.

For the operation of the diamond cutter 10, a first handle 22 is provided that has an operating device 23 and in the exemplary embodiment illustrated in FIG. 1 is in the form of a rear handle. The term “rear handle” means a handle that is located on the side of the motor housing 16 farther from the cutting disc 12. Alternatively, the first handle 22 can be a top handle that is located above the motor housing 16. For the guidance of the cutting disc 10, in addition to the first handle 22, a second handle 24 is provided which is located between the cutting disc 12 and the first handle 22. The second handle 24 in the exemplary embodiment illustrated in FIG. 1 is in the form of a tubular handle, or it can alternatively be constructed in one piece with the motor housing 16. Because the first handle 22, regardless of whether it is a rear handle or a top handle, is always located in the rear area of the tool apparatus 10 and therefore behind the second handle 24, we can speak in general of a rear handle 22 and a front handle 24.

The operating device 23 comprises a gas switch 25 for the actuation of the drive unit 13, a safety switch 26 for the unlocking of the gas switch 25 and a brake switch 27 for the actuation of the braking device 11. The actuator device 23 is located on the rear handle 22 and is operated by the operator using one hand. The gas switch 25 and the brake switch 27 are located on an inner side 28 of the rear handle 22 and can be operated, for example, with the index finger (gas switch 25) and the middle finger (the brake switch 27). The safety switch 26 is located on an outer side 29 of the rear handle 22 and can be operated, for example, with the palm of the hand or the inside of the hand.

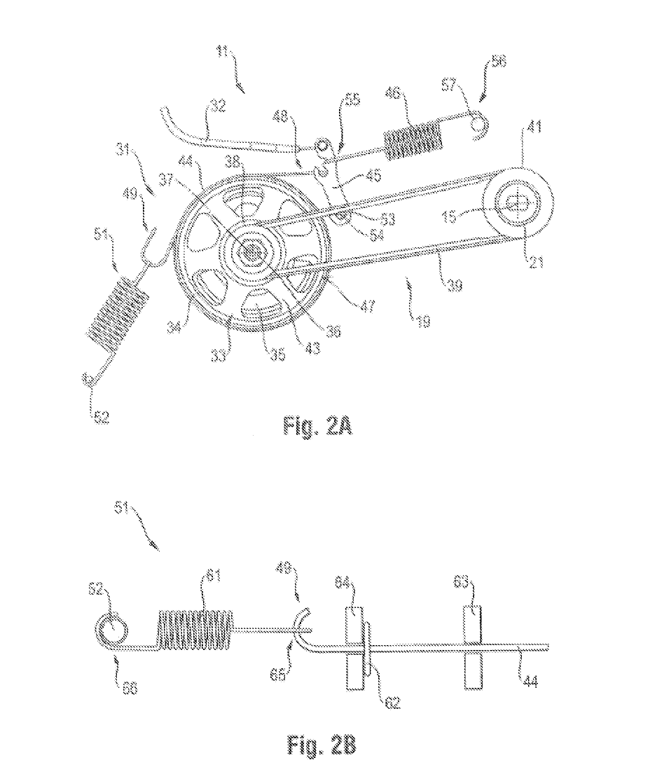

FIG. 2A shows the braking device 11 of the diamond cutter 10, which in addition to the brake switch 27 (illustrated in FIG. 1) consists of a mechanical band brake 31 and a transmission device 32. The transmission device 32 in FIG. 2A is in the form of a Bowden cable and transmits a movement of the brake switch 27 to the band brake 31, which acts on a centrifugal clutch 33 of the drive device 13. Alternatively, the transmission device 32 can be in the form of a cable pull, linkage or similar arrangement.

The centrifugal clutch 33 is located between the drive motor 17 and the belt drive 19 and ensures that the cutting disc 12 does not rotate at low speeds of rotation, such as during idle or during startup of the diamond cutter 10. The centrifugal clutch 33 has a clutch bell housing 34, against which flyweights 35 can be pressed outward during operation by centrifugal force. The drive motor 17 drives a crankshaft 36 around an axis of rotation 37. The clutch bell housing 34 is non-rotationally connected with a drive disc 38 that is mounted rotationally on the crankshaft 36. A drive belt 39 is guided over the drive pulley 38 and a driven pulley 41 mounted on the output shaft 21. The drive pulley 38, the drive belt 39 and the driven pulley 41 form the belt drive 19.

The band brake 31 comprises a brake drum 43, a brake band 44, a brake lever 45 and a brake spring 46. The clutch bell housing 34 of the centrifugal clutch 33 simultaneously forms the brake drum 43 of the band brake 31. The brake band 44 is wrapped around the brake drum 43 on its outer peripheral wall 47. The brake band 44 and the brake drum 43 form friction partners that work together during the braking and stopping of the clutch bell housing 34. By means of the brake spring 46, a bias is exerted on the brake lever 45 that causes a permanent tension force to be exerted on the brake band 44. The return force of the brake spring 46 causes the brake lever 45 to be rotated back into its base position if no external force is exerted on it. The braking device 11 is designed so that the band brake 31 is opened when the brake switch 27 is actuated and is closed when the brake switch 27 is released.

FIG. 2A illustrates one exemplary embodiment in which the clutch bell housing 34 of the centrifugal clutch 33 forms the brake drum 43 of the band brake 31. Alternatively, the brake drum can be a separate component and can be fastened by means of an adapter plate, for example, to a housing part of the diamond cutter 10. The integration of the brake drum 43 into the clutch bell housing 34 makes possible a compact construction and simultaneously saves weight for the tool apparatus. The separate configuration has the advantage that the band brake can be retrofitted on tools without major conversion effort or expense.

The brake band 44 has a first end 48 and a second end 49. The first end 48 of the brake band 44 is hooked onto the brake lever 45. The second end 49 is connected with an anti-blocking device 51 that is non-detachably connected on the other end with a housing part 52 of the diamond cutter 10. The brake lever 45 is mounted so that it can rotate around the pin 53 that is connected with the housing part 52 and defines an axis of rotation 54. The brake spring 46 has a free end 55 and a fixed end 56, wherein the free end 55 is hooked onto the brake lever 45 and the fixed end 56 is fastened to the housing part 52 by means of a pin 57.

FIG. 2B illustrates the construction of the anti-blocking device 51 of the band brake 31 in detail. The anti-blocking device 51 comprises a tension spring 61, a stop element 62, a first stop 63 and a second stop 64. The stop element 62 is connected with the brake band 44 and can be displaced between the first stop 63 and the second stop 64. The tension spring 61 has a free end 65 and a fixed end 66. The free end 65 is connected with the second end 49 of the brake band 44 and the fixed end 66 is fastened to the housing part 52. As an alternative to the anti-blocking device 51, the second end 49 of the brake band 44 can be a fixed end and can be non-detachably connected with the housing part 52 of the diamond cutter 10 by means of a pin, for example.

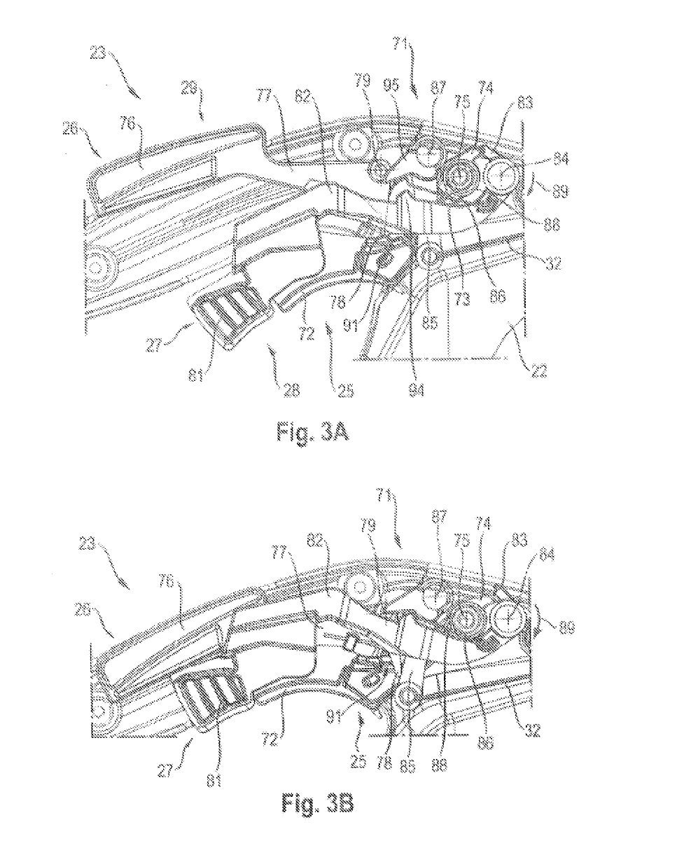

FIGS. 3A, B show the operating device 23 of the diamond cutter 10 with the gas switch 25, the safety switch 26 and the brake switch 27 in a base position of the brake switch 27 with the band brake 31 actuated (FIG. 3A) and in one terminal position of the brake switch 27 with an opened band brake 31 and actuated gas and safety switches 25, 26 (FIG. 3B). The operating device 23, in addition to the switches 25, 26, 27, has a device 71 that compensates for wear of the band brake 31 and is designated a compensator device.

The gas switch 25 consists of a grip section 72, a connecting section 73 and a stop 74 and can rotate around a first axis of rotation 75. The safety switch 26 comprises a grip section 76, a connecting section 77 and a stop 78 and can rotate around a second axis of rotation 79. The brake switch 27 consists of a grip section 81, a connecting section 82 and the stop 83 and can rotate around the third axis of rotation 84. The compensator device 71 comprises a lever 85 and a spring element 86 in the form of a leaf spring, and can rotate around an axis of rotation 87. The motion of the brake switch 27 is transmitted via the lever 85 to the transmission device in the form of Bowden cable 32. During the rotation of the brake switch 27, the connecting section 82 comes into contact with the lever 85 and rotates the lever 85 in the same direction around the axis of rotation 87. The Bowden cable 32 is connected on a first end with the brake lever 45 (FIG. 2) and a second end is connected with the lever 85. The Bowden cable 32 is tensioned by the rotation of the lever 85 around the axis of rotation 87.

The grip sections 72, 81 of the gas switch 25 and of the brake switch 27 respectively are located on the inner side 28 of the rear handle 22 and can be actuated by the operator with the index and middle finger, for example. The grip section 76 of the safety switch 26 is located on the outside 29 of the rear handle 22 and can be actuated by the operator using the inside of the hand, for example. The rear handle 22 consists of two housing shells that are connected to each other. In one of the 2 housing shells or in both housing shells, retaining elements are located on which the switches 25, 26, 27 and the lever 85 are installed. The switches 25, 26, 27 and the lever 85 can rotate around the retaining elements. The axes of rotation 75, 79, 84, 87 of the switches 25, 26, 27 and the compensator device 71 run parallel to one another.

By means of the torsion spring 88 a bias is exerted on the gas switch 25 and the safety switch 26. A first end of the torsion spring 88 is connected with the gas spring 25 and a second end is connected with the safety switch 26. The restoring force of the torsion spring 88 causes the gas switch 25 and the safety switch 26 to rotate back into their base position if no external force is exerted on them.

In the base position of the brake switch 27 illustrated in FIG. 3A, the braking device 11 of the diamond cutter 10 is active, i.e. the band brake 31 blocks the clutch bell housing 34 of the centrifugal clutch 33. The stop 83 of the brake switch 27 is in contact against the stop 74 of the gas switch 25 and blocks a rotation of the gas switch 25. The stop 78 of the safety switch 26 is also in contact against the connecting section 73 of the gas switch 25. To activate the drive device 13 of the diamond cutter 10 by means of the gas switch 25, the band brake 31 must be released by means of the brake switch 27 and the safety switch 26 must be actuated (FIG. 3B). The sequence in which the brake switch 27 and the safety switch 26 are activated does not play a role.

In the first variant, first the brake switch 27 is actuated. When the grip section 81 is actuated, the brake switch 27 is rotated in the direction 89 around the third axis of rotation 84. As a result of the rotation of the brake switch 27, the stop 83 of the brake switch 27 releases the stop 74 of the gas switch 25. The gas switch 25 is also blocked by the stop 78 of the safety switch 26, which is in contact against the connecting section 73 of the gas switch 25. If the safety switch 26 is actuated on the grip section 76, the safety switch 26 rotates around its axis of rotation 79. During the rotation around the axis of rotation 79, the stop 78 of the safety switch 26 enters into a connecting link 91 of the gas switch 25. The blocking of the gas switch 25 by the stop 78 of the safety switch 26 is neutralized. The gas switch 25 can now be actuated by the grip section 72.

In a second variant, first the safety switch 26 is actuated. When the grip section 76 is actuated, the safety switch 26 is rotated around its axis of rotation 79, the stop 78 of the safety switch 26 is inserted into the connecting link 91 of the gas switch 25 and releases the gas switch 25. The gas switch 25 is also blocked by the stop 83 of the brake switch 27, which is in contact against the stop 74 of the gas switch 25. If the brake switch 27 is rotated around its axis of rotation 84 in the direction 89 by an actuation of the grip section 72, the stop 83 of the brake switch 27 releases the stop 74 of the gas switch 75. The gas switch 25 can now be actuated by means of the grip section 72.

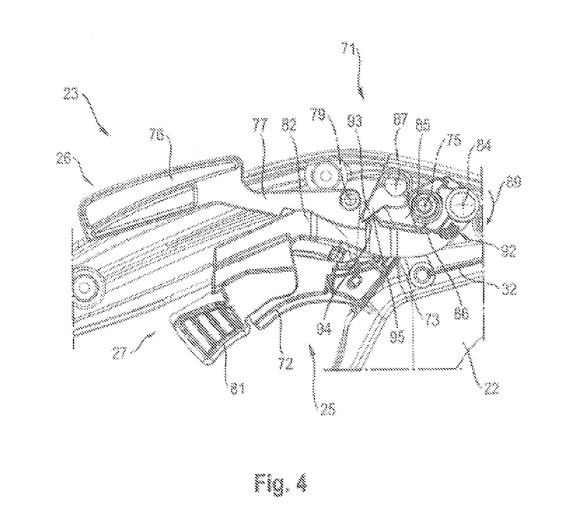

FIG. 4 shows the compensator device 71 of the braking device 11 in the base position of the brake switch 27 with a band brake 31 that has been altered by wear. For purposes of comparison FIG. 3A shows the braking device 11 in the base position when the band brake 31 is in new condition, i.e. without any wear.

With increasing use of the band brake 31, the dimensions of the brake band 44 and of the brake drum 43 change as a result of wear, the length of the brake band 44 increases and the diameter of the brake drum 43 decreases (FIG. 2). Consequently, the brake spring 46 contracts more strongly and rotates the brake lever 45 past its original base position toward the brake spring 46. The Bowden cable 32 that is connected with the brake lever 45 is stretched.

To compensate for these changes in length of the brake band 44 and of the brake drum 43, the compensator device 71 is provided, with the lever 85 that can rotate around the axis of rotation 87 and the leaf spring 86. The leaf spring 86 comprises a first end 92 which is not-detachably connected with the brake switch 27 and a second end 93 that is connected with a bias against the lever 85. When the grip element 81 is actuated, the brake switch 27 is rotated in the direction of rotation 89 around its axis of rotation 84. After the distance between them has been traveled, the brake switch 27 comes into contact with the lever 85 and both are rotated jointly around their respective axis of rotation 84 and 87. Because the Bowden cable 32 is fastened to the lever 85, the Bowden cable 32 is stretched during the rotation of the lever 85, the brake lever 45 rotates around its axis of rotation 54 and the brake spring 46 is extended.

To simplify the drive of the lever 85 and of the leaf spring 86 by the connecting section 82 of the brake switch 27, a driver 94 is provided on the connecting section 82 and a stop 95 on the lever 85. The leaf spring 86 also has on the second end 93 a shape that is complementary to the shape of the driver 94. In the exemplary embodiment illustrated in FIG. 4, the driver 94 and the second end 93 of the leaf spring 86 have a triangular shape.

FIG. 3A shows the compensator device 71 in the base position of the brake switch 27 when the band brake 31 is in new condition. The distance between the driver 94 and the stop 95 equals the maximum possible change of life that can be compensated by the compensator device 71. During the actuation of the brake switch 27, the operator must use the compensator device 71 to first overcome the free travel distance. The motion of the brake switch 27 is transmitted via the Bowden cable 32 to the band brake only when the brake switch 27 comes into contact with the lever 85 and the lever 85 is rotated in the direction of rotation 89 around its axis of rotation 87. FIG. 4 shows the compensator device 71 in the base position of the brake switch 27, in which the maximum possible change in the length of the band brake 31 is compensated by the compensator device 71. The driver 94 is already in the base position on the second end 93 of the leaf spring 86 and the lever 85 is driven directly when the grip section 81 is actuated. There is no free travel distance that must be overcome.

1-13. (canceled)

14. A hand-held tool apparatus with a braking device for braking a machining tool, comprising:
a rear handle for operating the hand-held tool apparatus;
a drive device, wherein the machining tool is drivable by the drive device around an axis of rotation;
a band brake including a brake drum and a brake band that wraps around the brake drum, wherein the brake band has a first end and a second end;
an operating device with a brake switch, wherein the brake switch is connected via a transmission device to the first end of the brake band; and
a rotationally mounted compensator device disposed between the transmission device and the brake switch.

15. The hand-held tool apparatus according to claim 14, wherein the compensator device includes a rotationally mounted lever connected to the transmission device and a spring element, wherein the spring element is connected on a first end with the brake switch and is in contact on a second end under bias with the lever.

16. The hand-held tool apparatus according to claim 15, wherein the spring element is a leaf spring and wherein a driver for the leaf spring is provided on the brake switch.

17. The hand-held tool apparatus according to claim 16, wherein the second end of the leaf spring that is in contact with the lever has a shape that is complementary to a shape of the driver.

18. The hand-held tool apparatus according to claim 15 further comprising a rotationally mounted brake lever disposed between the first end of the brake band and the transmission device, wherein the rotationally mounted brake lever is biased by a brake spring.

19. The hand-held tool apparatus according to claim 18, wherein a spring stiffness of the spring element is less than a spring stiffness of the brake spring.

20. The hand-held tool apparatus according to claim 14, wherein the operating device has a gas switch for actuation of the drive device and a safety switch for unlocking of the gas switch, wherein the brake switch is separate from the gas switch and from the safety switch.

21. The hand-held tool apparatus according to claim 20, wherein the gas switch and the brake switch are disposed on an inner side of the rear handle and wherein the safety switch is disposed on an outer side of the rear handle.

22. The hand-held tool apparatus according to claim 14, wherein a tension spring is disposed between the second end of the brake band and a housing part of the hand-held tool apparatus.

23. The hand-held tool apparatus according to claim 22, wherein a maximum extension of the tension spring is limited by a first stop.

24. The hand-held tool apparatus according to claim 23, wherein a minimum extension of the tension spring is limited by a second stop.

25. The hand-held tool apparatus according to claim 24, wherein the brake band has a stop element that is displaceable between the first stop and the second stop.

26. The hand-held tool apparatus according to claim 22, further comprising a rotationally mounted brake lever disposed between the first end of the brake band and the transmission device, wherein the rotationally mounted brake lever is biased by a brake spring and wherein a spring stiffness of the tension spring is greater than a spring stiffness of the brake spring.
